(19) United States
(12) Patent Application Publication
(10) Pub. No.: US 2001/0033903 A1
(43) Pub. Date: Oct. 25, 2001

(54) Tray of thermoplastic material for the packaging of foodstuffs which tend to release bad smelling volatile substances

(76) Inventors: Piergiovanni Luciano, Rodano (IT); Federico Lanzani, Verolanuova (IT); Renato Mauri, Manerbio (IT); Matteo Brazzoli, Piacenza (IT); Patrizia Fava, Piacenza (IT)

Correspondence Address: YOUNG & THOMPSON, 745 SOUTH 23RD STREET 2ND FLOOR, ARLINGTON, VA, 22202

(21) Appl. No.: 09/761,694

(22) Filed: Jan. 18, 2001

(30) Foreign Application Priority Data
Jan. 18, 2000 (EP) 00830018.8

(51) Int. Cl. B29D 22/00; B65D 3/00; B32B 1/08; F16L 1/00; B65D 5/56; B65D 5/62; B65D 1/00; B29D 23/00

(52) U.S. Cl. 428/34.1; 428/35.8; 229/5.84

(57) ABSTRACT

A tray for packaging food products which may release smelly volatile substances produced from a sheet of substantially open-cell expanded thermoplastic material containing a finely divided solid material provided with adsorbing properties towards said substances, such as for example aluminium oxide, bentonite, kaolin, activated charcoal, zeolites, synthetic polymers with a high melting point such as polyphenyloxide and polyimides, graphite, mica, diatomaceous earth, pumice and clay; the inner surface of said tray is preferably provided with apertures.

### TECHNICAL FIELD

The present invention relates in general to the packaging of food products.

Specifically, the invention relates to a container of expanded thermoplastic material for packaging food products which may release smelly volatile substances (the so-called off-flavors), such as, for example, fishery products (fish, shellfish and the like), cooked food, especially if egg-based.

### TECHNOLOGICAL BACKGROUND

For the sake of brevity, in the following description reference shall be made to fish, although it must be understood that what illustrated and exemplified with reference to fish also applies to the above foods. It is known that the preservation of fresh fish is quite difficult, because few hours after fish has been fished, its proteins begin to deteriorate, thus generating volatile smelly substances, among which, in particular, amine compounds are to be found. All this happens when fish still has excellent hygienic, nutritional and taste characteristics.

Moreover, if fish is packaged, as a whole or in fillets, into trays of thermoplastic material sealed with a suitable film of plastic material, volatile amines generated by the incipient protein deterioration concentrate into the inner volume of the package, and will be released when the package is opened.

The release of volatile amines is very unpleasant to the consumer, who is moreover wrongly led to believe that the off-flavor is a sign of a bad preservation of the food.

Some solutions have been proposed in the prior art to the above inconvenience. The first solution involves the addition of organic acids, such as citric acid, and of iron salts to films made of a thermoplastic material, with which packaging bags are made. In the presence of the organic acid and of the iron salt, volatile amines would be oxidized as soon as they are absorbed by the polymer, thus losing their typical smell. Nevertheless, the nature of the oxidized products thus obtained is not clear, nor has been their harmlessness assessed.

Patent application EP-A 0 294 165 describes a package for fresh fish obtained by arranging the food into a tray made of a resin having barrier properties with respect to gases, together with a deoxidant and/or in an atmosphere of nitrogen or nitrogen and carbon dioxide, then sealing said container.

An example of deoxidant is a bag containing a particular iron-based powder which is capable of removing oxygen.

Also in this case, the nature of the products originating from the interaction of the above powder with volatile amine compounds is not very clear.

The problem underlying the present invention is that of providing a tray for packaging food that may release smelly volatile compounds, such as fish and the like, which should allow to remarkably reduce the odor perception of said compounds when the package is opened by the consumer.

### SUMMARY OF THE INVENTION

According to the invention, said problem is solved, by a tray for packaging food which may release smelly volatile substances, produced from a sheet of substantially open-cell, expanded thermoplastic material containing a finely-divided solid material provided with adsorbing properties with respect to said substances.

Such a material can be selected from the group comprising aluminium oxide, bentonite, kaolin, activated charcoal, zeolites, synthetic polymers having a high melting point such as polyphenyloxide and polyimides, graphite, mica, diatomaceous earth, pumice and clay.

Aluminium oxide is particularly preferred, used in amounts comprised between 0.5 and 8%, advantageously between 1.5 and 4%, by weight of the total weight of the plastics sheet. The tray according to the present invention is preferably provided with apertures onto its inner surface.

These apertures can, for example, be made up of holes having a diameter of 0.1-1.5 mm, which extend into the thickness of the sheet.

These apertures have the purpose of putting the open-cell structure of the sheet, wherein the finely-divided solid material is distributed over a very large surface, into contact with the smelly volatile substances, thus favoring their adsorption.

The open cells of the sheet from which the tray according to the invention is formed are at least 50% of the total cells.

The solid material provided with adsorbing properties preferably has particles of size comprised between 0.5 and 100 μm.

Aluminium oxide, also commonly referred to as alumina, preferably has particles size comprised between 1.0 and 80 μm; preferably, between 5 and 30 μm. The plastic material forming the sheet is selected from the group comprising polystyrene, polyethylene, polyethylene terephthalalate, polypropylene, polyvinylchloride, and other polymers or copolymers adapted for food packaging. Use of polystyrene is preferred.

The tray according to the invention can be coated, on one or both surfaces, with a film or a thin layer made of non-expanded plastic material for the purpose of improving its mechanical resistance properties. In this case, said film or thin layer will be in turn provided with apertures in correspondence with the inner surface of the tray.

The sheet of substantially open-cell expanded thermoplastic material containing a finely-divided solid material provided with adsorbing properties can be prepared with an ordinary extrusion method to obtain open-cell expanded sheets after adding to the mixture of starting materials, i.e. at least one thermoplastic polymer and a nucleating agent, a suitable quantity of a finely-divided solid material provided with adsorbing properties and a blowing agent.

Procedures for producing sheets of open-cell expanded thermoplastics material are well known in the art; reference may be made, for example, to Klempner and Frisch “Handbook of Polymeric Foams and Foam Technology”, Carl Hanser Verlag, 1991. Specific methods are described, for example, in EP-A 0 090 507, U.S. Pat. No. 3,610,509, EP-A 0 642 907 and EP 0 849 309.

The nucleating agent can be selected among the most used ones, such as for example talc, calcium carbonate, citric acid and sodium bicarbonate, Hydrocerol®, chalk, etc.

The nucleating agent may also not be added if an extrusion method is used, such as that described in patent application U.S. Pat. No. 5,586,053.

As blowing agents, one or more compounds may be used, selected among lower aliphatic hydrocarbons, HFC's, nitrogen, carbon dioxide and mixtures thereof.

Moreover, in place of a mixture of polystyrene and a blowing agent, it is possible to use expandable polystyrene, that is to say, polystyrene granules including a lower aliphatic hydrocarbon which acts as a blowing agent.

Moreover, it is advantageously possible to add a surfactant to the mixture of starting materials. In this case, besides absorbing the smelly amine compounds, the tray shall also provide for an effective absorption, within its open-cell structure, of possible liquids released by the food.

As surfactants, it is possible to use the usual anionic, cationic, non-ionic and amphoteric surface-active agents, and preferably salts of alkyl- or alkylarylsulfonic acids with alkali or alkaline-earth metals, or salts of sulfuric esters R—OSO₃H, wherein R is alkyl or alkylaryl, with an alkali or alkaline-earth metal.

Alumina, or aluminium oxide (Al₂O₃), which is the preferred adsorbent for the purposes of the present invention, is a white and amorphous powder, insoluble in water and acids, with strong adsorbing properties with respect to humidity and volatile substances. Thanks to these characteristics, it is widely used as stationary phase in chromatography. The adsorbing properties of alumina vary according to the specific surface of the particles, and thus, to the granulometry, and according to the treatments which it has been subjected to. In particular, the adsorbing properties are maximum for anhydrous alumina, and they can be modulated by metered additions of water. Moreover, the treatment of alumina with acid or basic solutions allows imparting selective adsorbing properties.

The above properties have always been referred to powder alumina as such, and never to alumina incorporated into any polymer matrix.

Now, it has been surprisingly noted that, also when incorporated into an open-cell thermoplastics matrix, alumina has excellent adsorbing properties towards smelly volatile substances, in particular amine compounds, such as trimethylamine, which is one of the main products from the degradation of animal tissues. In particular, the concentration of trimethylamine which accumulates into the tissues of fishery products is often used as index of sensorial degradation of the product (Castnell et al., 1971, Some fundamental problems in the quality assessment of fishery products in “Fish inspection and quality control”—Fishery News Ltd.; London).

The substantially open-cell structure of the sheet of expanded thermoplastic material according to the present invention plays a very important role in facilitating the action of the adsorbent material, as it allows distributing said material on a very large surface, what facilitates the picking up action of the adsorbent material on the molecules of smelly substances.

In fact, it has been calculated that the exchange surface provided by the substantially open-cell structure of a tray according to the invention having about 85% of open cells is 30-40 times larger than the surface of the tray itself.

Thus, the effect of adsorption of smelly molecules by the adsorbent material is greater than that which the latter would display if incorporated into a closed-cell expanded thermoplastic material or into a film or layer of non-expanded thermoplastic material. In addition, since the mean thickness of a wall of a cell of the open-cell expanded sheet according to the invention is in the order of magnitude of 1 μm, and the particles of the adsorbent material typically have a mean dimension of few dozens μm, whether the particles are inside a cell wall, or in the ribs, the polymeric material enveloping them has a minimum thickness, in any case smaller than the thickness of the polymeric material which would surround the same particles if they were dispersed in a film of thermoplastic material. In this way, on the one hand, the polymeric material has not such a thickness as to sensibly reduce the adsorbing effect of the finely-divided material with respect to the smelly volatile molecules; on the other hand, it protects said material from the deactivation caused by the moisture that may be present in the food.

Finally, the adsorbent material used for the trays according to the invention is not susceptible of causing or catalyzing chemical reactions involving the volatile substances, as it happens, on the contrary, with the above-mentioned packages of the prior art. Thus, compounds of unclear nature or potentially harmful are not generated.

The present invention will be now further illustrated with reference to the attached drawings, to an example of production of a tray according to the invention, and to some tests of instrumental and organoleptic evaluation carried out on the same.

### BRIEF DESCRIPTION OF THE DRAWINGS

FIG. 1 shows a perspective view of a tray according to the invention.

FIG. 2 shows a partial section of a tray according to the invention.

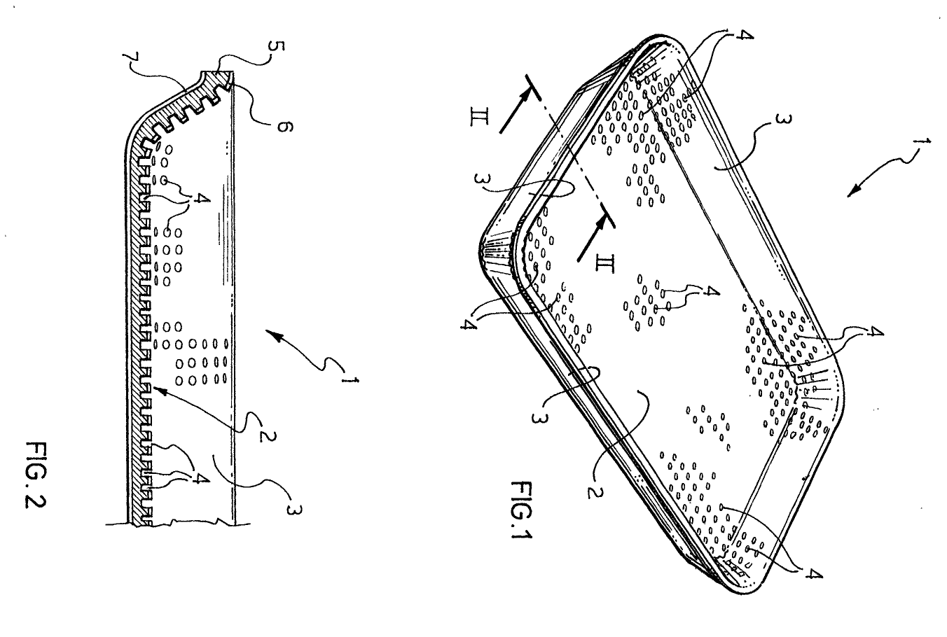

### DETAILED DESCRIPTION OF THE INVENTION

### EXAMPLE

108.5 kg of EXTIR® 1910 crystal polystyrene produced by ENICHEM were mixed with 19.6 kg of SR 550 shockproof polystyrene (HIPS) (ENICHEM) and with 7 kg of CSFB0014 masterbatch produced by the firm Ferro Italia, containing 60% of talc with dimensions of particles of about 5 μm. Moreover, 4.9 kg of MA 250 powder alumina by the firm ALCAN were added, having average particle size of about 10 μm. The total supply of solid material was of 140 kg/h.

The mixture thus obtained was fed to an LMP 19E double-screw extruder, in which liquid butane was injected (6 kg/h) as a blowing agent.

The temperature profile in the various regions of the extruder was as follows:

| | |
|---|---|
| T1 | 261° C. |
| T2 | 260° C. |
| T3 | 259° C. |
| T4 | 124° C. |
| T5 | 122° C. |
| T6 | 120° C. |
| T7 | 118° C. |
| T8 | 119° C. |
| T9 | 114° C. |
| T10 | 109° C. |

The speed of the screw of the extruder was of 30 rev. per minute, and the pressure of the die reached 55 bar.

The temperature of the molten mixture exiting from the die was of about 115° C. The aperture of the annular die was of 0.9 mm.

The characteristics of the expanded sheet thus obtained were as follows:

| | | |
|---|---|---|
| basic weight | 300 | g/m² |
| thickness | 5.5 | mm |
| density | 55 | g/l |
| content of open cells | 89% | |

The tubular body of expanded polystyrene was then cut and conducted through a calender made up of a pair of rollers to stretch it out according to the conventional method of extrusion of expanded sheets. At that point, one of the two surfaces of the expanded sheet was coated with a layer having a 60-μm thickness obtained from the extrusion of a mixture of 50% polystyrene and 50% HIPS of the above-mentioned types into a separate extruder.

The coated expanded sheet thus obtained was hot-laminated on the uncoated surface with an opaque oriented polystyrene film, having a 25-μm thickness, and the laminated surface was then perforated with metal needles having a diameter of 0.1-1.5 mm, so that the holes were at a distance of 10 mm from one another.

Finally, the sheet thus obtained was wound up to form a coil and then was sent to the conventional thermoforming apparatus to produce trays having an inner surface laminated with the OPS film and crossed by the above holes.

The trays thus obtained comprise a body 1 provided with a base 2, having holes 4, and with side walls 3.

With reference to FIG. 2, the structure of the tray is made up of the above open-cell expanded polystyrene sheet 5, the upper surface of which is laminated with an OPS film 6, and the lower surface of which is coated with a non expanded 1:1 HIPS polystyrene/polystyrene layer 7. Film 6 is provided with a series of holes 4 with a diameter of 0.1-1.5 mm, which extend into the thickness of sheet 5.

Some sole fillets fished not more than 12 hours before, were laid into ten of the trays thus obtained (about 300 g of fillets for each tray). Then, the tray was sealed inside a package of plastics material having barrier properties with respect to gases, after having injected a protective atmosphere made up of a mixture of nitrogen and carbon dioxide 6:4.

In parallel, the same operations were carried out with ten trays of standard closed-cell polystyrene not charged with alumina, with identical values of basic weight and thickness.

After 3,.7 and 10 days, the trimethylamine (TMA) levels were measured in the head space of the packages. Said measurement was carried out with the GC HS technique (gas chromatography of the head space) by means of the instrument HS40 of the firm Perkin—Elmer together with a 5900 series II gas chromatograph by the firm Hewlett Packard.

First of all, to measure the TMA in the head space of the packages, an adsorption system had to be used made up of a diaphragm compressor for sucking the gaseous atmosphere inside the packages, connected by means of a flowmeter for regulating the adsorption speed, to a glass cartridge packed with adsorbent material and immersed into refrigerated water at 9° C. In turn, the cartridge was connected to the package to be analyzed by means of a needle introduced through a septum of silicone rubber.

As the adsorbent material, the cartridges contained TENAX® polyphenyloxide in a quantity equal to 200 mg; they had a cylindrical shape (length of 6.5 cm and inner diameter of 0.3 cm), and they had been previously thermostated for 5 minutes at 9° C. in the water bath of a HAAKE CH thermostat before starting the adsorption.

Once the atmosphere of the packages had been adsorbed, the cartridges were introduced into hermetically closed vials, and were analyzed at the head space.

The results obtained are as summarized in Table 1.

TABLE 1

| | | |
|---|---|---|
| After 3 days | After 7 days at | After 10 days |
| at 3° C. | at 3° C. | at 3° C. |

| | TMA | TOT | TMA | TOT | TMA | TOT |
|---|---|---|---|---|---|---|
| | (a.u.) | (a.u.) | (a.u.) | (a.u.) | (a.u.) | (a.u.) |
| A | 3528 | 5755 | 6287 | 15169 | 6093 | 19548 |
| B | 16346 | 18342 | 30000 | 54000 | 72101 | 78232 |

In Table 1, A refers to the tray with alumina, B refers to the standard tray; the abbreviation “TOT” refers to the total volatile components adsorbed, and initials “a.u.” refer to the “area units” absorbed in the gas chromatogram.

The data above clearly shows that the atmosphere in the packages obtained with the tray produced according to example 1 (hereafter referred to as “tray with alumina”) had a content of volatile compounds, and in particular, of trimethylamine, significantly lower than that of the atmosphere of packages made with a standard closed-cell polystyrene tray having the same basic weight and thickness. This is an indirect demonstration that smelly volatile compounds had been to a large extent adsorbed by the tray according to the invention.

A further confirmation of the adsorbing properties of the tray according to the invention with respect to smelly volatile substances came from the results of a sensory evaluation test.

Also in this case, fillets of fresh sole were packaged (about 300 g for each package) into trays prepared according to example 1 and, for comparison, into standard closed-cell polystyrene trays having the same basic weight and thickness. In both cases, the trays were closed into bags of plastics material having barrier properties with respect to gases, wherein a protective atmosphere made up of a mixture of nitrogen/carbon dioxide 6:4 was imposed.

Sensory evaluations were carried out by means of panels of selected “tasters” trained to recognize the components (the so-called “descriptors”) of the typical fish flavor, which are as follows:

flavor of watermelon or melon;

flavor of seaweed and grass;

putrid flavor (associated to the decomposition of animal and vegetal products);

ammoniac flavor (typical of old or deteriorated fish);

flavor of lactic fermentation.

In sensory analyses, the method of difference was applied with respect to a reference (M. Meilgaard et al., Sensory evaluation techniques, II ed. CRC Press, Boca Raton (Fla.)), which allows verifying a difference between the experimental and the reference sample. The difference was evaluated both in relation to the above descriptors of fish flavors (Olafsdottir G. et al., “Methods to evaluate fish freshness in research and industry”, Trends in Food Sci. Technology, 8:258-265; 1997) and in relation to a global visual and olfactory evaluation.

The test was conducted with a selected and trained panel of 21 subjects aged between 20 and 30, who were asked to evaluate the differences between the samples and the reference, made up of non-packaged fresh fish. The tasting sessions were carried out according to the procedure reported in the scientific literature of the field (H. J. H. Macfie, N. Bratchell, K. Greenhoff, L. Y. Vallis, 1989, “Designs to balance the effect of order of presentation and first-order carry-over effects in Hall tests”, J. Sensory Stud., 4, 129-148).

After proper training sessions, the evaluators were asked to indicate, for each sample, on a fixed linear scale, the degree of distance from the reference (fresh fish) for each descriptor. Afterwards, scores were calculated by assigning values comprised between 0 and 100 to the extremes of the scale. The value equal to zero refers to fresh fish, whereas the value equal to 100 refers to definitely rotten fish.

The results provided by the evaluators were subjected to statistical validation, thus obtaining the results summarized in the following table, in which A refers to packages comprising a tray according to the invention, and B refers to packages comprising a standard closed-cell polystyrene tray having the same basic weight and thickness.

TABLE 2

| | A after 3 | B after 3 | A after 7 | B after 7 |
|---|---|---|---|---|
| | days at | days at | days at | days at |
| | 3° C. | 3° C. | 3° C. | 3° C. |
| Descriptor | (distance) | (distance) | (distance) | (distance) |
| Flavor of | 23.74 | 33.00 | 34.24 | 37.93 |
| watermelon/melon | | | | |
| Flavor of | 24.91 | 41.95 | 34.02 | 44.10 |
| seaweed/grass | | | | |
| Putrid flavor | 7.81 | 19.31 | 21.22 | 26.05 |
| Ammoniac flavor | 9.12 | 16.88 | 13.14 | 16.48 |
| Flavor of lactic | 14.76 | 22.91 | 36.07 | 44.12 |
| fermentation | | | | |
| Global | 20.10 | 36.07 | 38.00 | 48.43 |
| Evaluation | | | | |

The data after 3 days at 3° C.—which corresponds to the period during which packaged fish is usually put up for sale in cold counters - was especially significant. It can be noticed that the distance with respect to fresh fish is significantly reduced for packages comprising the tray according to the invention with respect to those containing the conventional polystyrene trays. Moreover, also the small difference over the reference fresh fish with regard to the ammoniac flavor and the putrid flavor must be noted.

We claim:

1. A tray for packaging food products which release smelly volatile substances, produced from a sheet of substantially open-cell expanded thermoplastic material containing a finely divided solid material provided with adsorbing properties towards said substances.

2. A tray according to claim 1, having an inner surface provided with apertures.

3. A tray according to claim 2, wherein said material is selected from the group comprising aluminium oxide, bentonite, kaolin, activated charcoal, zeolites, synthetic polymers with a high melting point such as polyphenyloxide and polyimides, graphite, mica, diatomaceous earth, pumice and clay.

4. A tray according to claim 3, wherein said material has particles with an average particle size comprised between 0.5 and 100 μm.

5. A tray according to claim 4, wherein said material is powder aluminium oxide with particle sizes comprised between 5 and 30 μm.

6. A tray according to claim 5, wherein the content of aluminium oxide is comprised between 0.5 and 8% by weight of the total weight of said sheet of expanded thermoplastic material.

7. A tray according to claim 6, wherein the content of aluminium oxide is comprised between 1.5 and 4% by weight of the total weight of said sheet of expanded thermoplastic material.

8. A tray according to claim 2, wherein said thermoplastic material is selected from the group comprising polystyrene, polyethylene, polyethylene terephthalate, polypropylene, polyvinylchloride, and copolymers thereof.

9. A tray according to claim 8, wherein said thermoplastic material is polystyrene.

10. A tray according to claim 6, wherein said thermoplastic material is selected from the group comprising polystyrene, polyethylene, polyethylene terephthalate, polypropylene, polyvinylchloride, and copolymers thereof.

11. A tray according to claim 6, wherein said thermoplastic material is polystyrene.

12. A tray according claim 2, wherein said sheet contains at least one surfactant.

13. A tray according to claim 10, wherein said sheet contains at least one surfactant.

14. A sheet of substantially open-cell expanded thermoplastic material provided with apertures on at least one of its surfaces, and having the property of adsorbing smelly volatile substances, which sheet contains at least 0.5% by weight of a powder material provided with adsorbing properties towards said substances.

15. A sheet of expanded thermoplastic material according to claim 14, wherein said material is selected from the group comprising aluminium oxide, bentonite, kaolin, activated charcoal, zeolites, synthetic polymers with a high melting point such as polyphenyloxide and polyimides, graphite, mica, diatomaceous earth, pumice and clay.

16. A sheet according to claim 15, wherein said material has particles with average particle size comprised between 0.5 and 100 μm.

17. A sheet according to claim 16, wherein said material is powder aluminium oxide with particle size comprised between 5 and 30 μm.

18. A sheet according to claim 17, wherein the content of aluminium oxide is comprised between 0.5 and 8% by weight of the total weight of said sheet of expanded thermoplastic material.

19. A sheet according to claim 18, wherein the content of aluminium oxide is comprised between 1.5 and 4% by weight of the total weight of said sheet of expanded thermoplastic material.

20. A sheet according to claim 14, wherein said thermoplastic material is selected from the group comprising polystyrene, polyethylene, polyethylene terephthalate, polypropylene, polyvinylchloride, and copolymers thereof.

21. A sheet according to claim 18, wherein said thermoplastic material is selected from the group comprising polystyrene, polyethylene, polyethylene terephthalate, polypropylene, polyvinylchloride, and copolymers thereof.

22. A sheet according to claim 20, wherein said thermoplastic material is polystyrene.

23. A sheet according to claim 21, wherein said thermoplastic material is polystyrene.

24. A sheet according to claim 14, containing at least one surfactant.

25. A sheet according to claim 21, containing at least one surfactant.

26. A method for packaging food products that release smelly volatile substances, comprising the steps of arranging said food products on a tray made of an open-cell expanded thermoplastic material, provided with apertures on the inner surface and including a powder material provided with adsorbing properties towards said substances; and sealing everything in a protective atmosphere by means of a wrapping of plastics material having barrier properties with respect to gases.
